(19) United States
(12) Patent Application Publication
(10) Pub. No.: US 2018/0051627 A1
(43) Pub. Date: Feb. 22, 2018

(54) GAS GENERATOR BIFURCATING EXHAUST DUCT TO FREE TURBINE

(71) Applicant: United Technologies Corporation, Farmington, CT (US)

(72) Inventors: Jesse M. Chandler, South Windsor, CT (US); Gabriel L. Suciu, Glastonbury, CT (US)

(21) Appl. No.: 15/239,086

(22) Filed: Aug. 17, 2016

(51) Int. Cl. F02C 3/10; F02C 7/36; F01D 25/30; F02K 3/12; B64D 27/10; B64D 33/04; B64D 33/02

(52) U.S. Cl. CPC F02C 3/10; F02C 7/36; F01D 25/30; F02K 3/12; F05D 2260/40311; B64D 33/04; B64D 33/02; F05D 2220/32; F05D 2250/314; B64D 27/10

(57) ABSTRACT

A gas turbine engine for an aircraft includes a core engine assembly including a compressor section communicating air to a combustor section where the air is mixed with fuel and ignited to generate a high-energy gas flow that is expanded through a turbine section. The turbine section is coupled to drive the compressor section. A free turbine is configured to be driven by gas flow from the core engine. A propulsor section aft of the core engine and is driven by the free turbine. An exhaust duct routes exhaust gases from the core engine to the free turbine. The free turbine is disposed aft of the propulsor section and the exhaust duct includes an outlet aft of the propulsor section communicating gas flow to drive the free turbine. An aircraft is also disclosed.

### STATEMENT REGARDING FEDERALLY SPONSORED RESEARCH OR DEVELOPMENT

This subject of this disclosure was made with government support under Contract No.: NND15AC56C awarded by NASA. The government therefore may have certain rights in the disclosed subject matter.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-energy exhaust gas flow expands through the turbine section to drive the compressor and the fan section.

A speed reduction device such as an epicyclical gear assembly driven by a core engine enables alternative placement of the gas turbine engine. The core components of the gas turbine engine such as the compressor, combustor and turbine can be imbedded within the aircraft body. A fan section may then be mounted in alternate locations such as at the rear of the aircraft body. In such a configuration the fan is aft of the core engine components and exhaust gases flow past the fan. It is not desirable to ingest the hot exhaust gases into the fan.

### SUMMARY

In a featured embodiment, a gas turbine engine for an aircraft includes a core engine assembly including a compressor section communicating air to a combustor section where the air is mixed with fuel and ignited to generate a high-energy gas flow that is expanded through a turbine section. The turbine section is coupled to drive the compressor section. A free turbine is configured to be driven by gas flow from the core engine. A propulsor section aft of the core engine and is driven by the free turbine. An exhaust duct routes exhaust gases from the core engine to the free turbine. The free turbine is disposed aft of the propulsor section and the exhaust duct includes an outlet aft of the propulsor section communicating gas flow to drive the free turbine.

In another embodiment according to the previous embodiment, the free turbine drives a shaft coupled to the propulsor section.

In another embodiment according to any of the previous embodiments, includes a gear system driven by the free turbine for driving the propulsor section at a speed different than a speed of the free turbine.

In another embodiment according to any of the previous embodiments, the free turbine includes a radial inflow turbine and the outlet of the exhaust duct is disposed transverse to the radial inflow turbine to direct exhaust gas flow radially into the radial inflow turbine.

In another embodiment according to any of the previous embodiments, the free turbine includes an axial inflow turbine and the outlet is disposed aft of the propulsor and forward of the axial inflow turbine.

In another embodiment according to any of the previous embodiments, exhaust duct includes an inflow section that communicates exhaust gases to the outlet, and the outlet is annular and surrounds the shaft.

In another embodiment according to any of the previous embodiments, the exhaust duct includes a turning portion that turns exhaust gas flow radially inward to the free turbine.

In another embodiment according to any of the previous embodiments, includes a bifurcation that extends through a flow path of the propulsor and the turning portion is disposed within the bifurcation.

In another embodiment according to any of the previous embodiments, the core engine is angled outward relative to a longitudinal axis of the aircraft.

In another embodiment according to any of the previous embodiments, the core engine includes first and second core engines disposed within the aircraft and first and second propulsors driven by a corresponding first and second core engine.

In another featured embodiment, an aircraft includes a core engine assembly supported within an aircraft fuselage. The core engine assembly includes a compressor section communicating air to a combustor section where the air is mixed with fuel and ignited to generate a high-energy gas flow that is expanded through a turbine section. An air intake within the aircraft fuselage communicates air to the core engine assembly. A propulsor section is aft of the core engine. A free turbine is configured to be driven by gas flow from the core engine. The free turbine is aft of the propulsor section and drives a shaft coupled to the propulsor section. An exhaust duct routes exhaust gases from the core engine to the free turbine and the exhaust duct includes an outlet aft of the propulsor section communicating gas flow to drive the free turbine.

In another embodiment according to the previous embodiment, the free turbine includes a radial inflow turbine and the outlet of the exhaust duct is disposed transverse to the radial inflow turbine to direct exhaust gas flow radially into the radial inflow turbine.

In another embodiment according to any of the previous embodiments, includes a gear system configured to drive the propulsor section at a speed different than that of the free turbine.

In another embodiment according to any of the previous embodiments, the free turbine includes an axial inflow turbine and the outlet is disposed aft of the propulsor and forward of the axial inflow turbine.

In another embodiment according to any of the previous embodiments, exhaust duct includes an inflow section that communicates exhaust gases to the outlet, and the outlet is annular and surrounds the shaft.

In another embodiment according to any of the previous embodiments, the exhaust duct includes a turning portion that turns exhaust gas flow radially inward to the free turbine.

In another embodiment according to any of the previous embodiments, includes a bifurcation that extends through a flow path of the propulsor and the turning portion is disposed within the bifurcation.

In another embodiment according to any of the previous embodiments, the core engine is angled outward relative to a longitudinal axis of the aircraft.

In another embodiment according to any of the previous embodiments, the core engine includes a first core engine and a second core engine disposed within the aircraft and the propulsor section includes a first propulsor driven by the first core engine and a second propulsor driven by the second core engine.

In another embodiment according to any of the previous embodiments, the first core engine and the second core engine are each angled outward relative to a longitudinal axis of the aircraft.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example aircraft including a partially embedded propulsion system.

FIG. 2 is an aft view of the example aircraft including the partially embedded propulsion system.

FIG. 3 is a schematic side view of the example embedded propulsion system.

FIG. 4 is a schematic illustration of an example core engine.

FIG. 5 is a schematic illustration of an orientation of core engines disposed within the example aircraft.

FIG. 6 is a schematic view of a free turbine embodiment.

FIG. 7 is a schematic view of the free turbine of FIG. 6.

FIG. 8 is an aft view of an example propulsor.

FIG. 9 is an aft view of another free turbine embodiment.

FIG. 10 is an aft view of the free turbine of FIG. 9.

### DETAILED DESCRIPTION

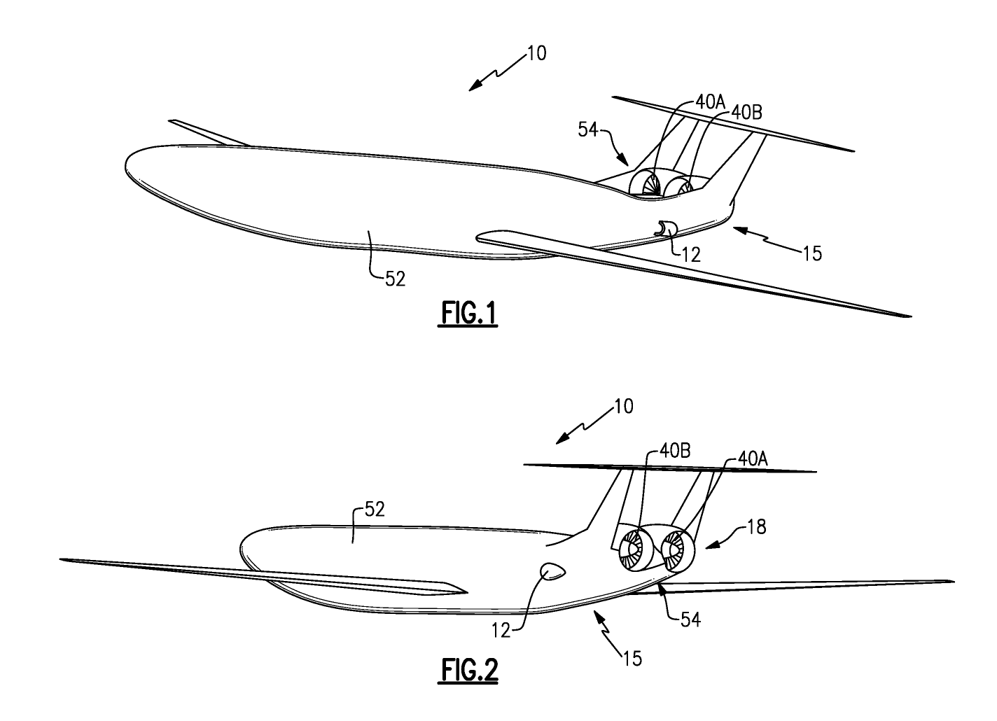

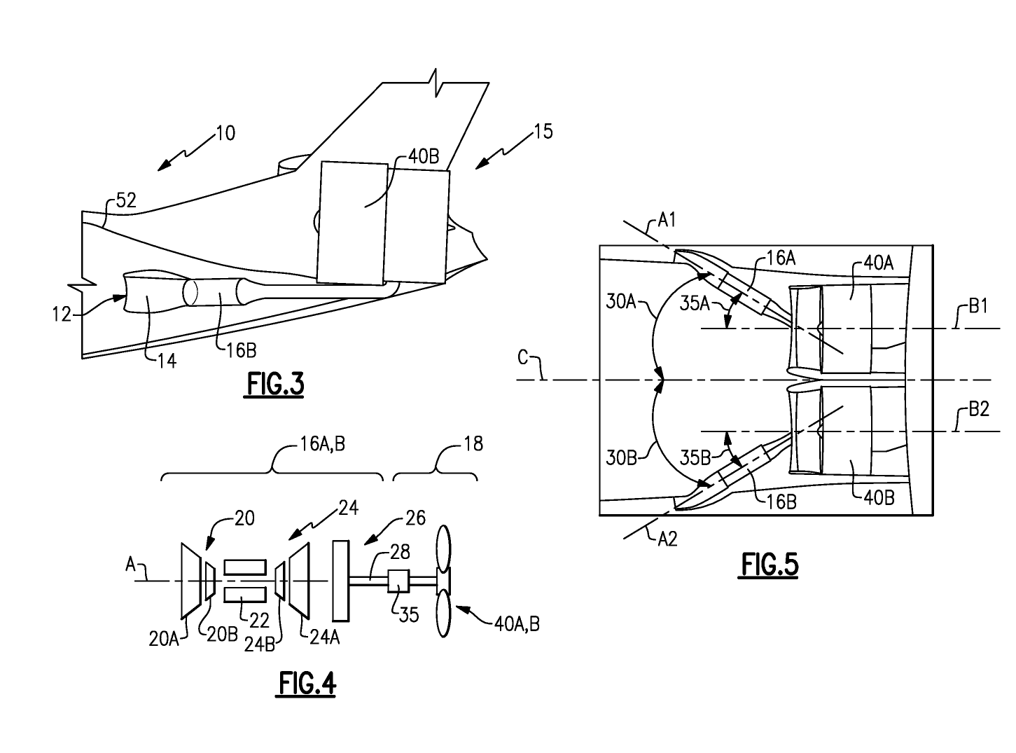

FIGS. 1, 2 and 3 schematically illustrate an aircraft 10 that includes an embedded propulsion system 15. The example propulsion system 15 includes a core engine 16 and a propulsor 18.

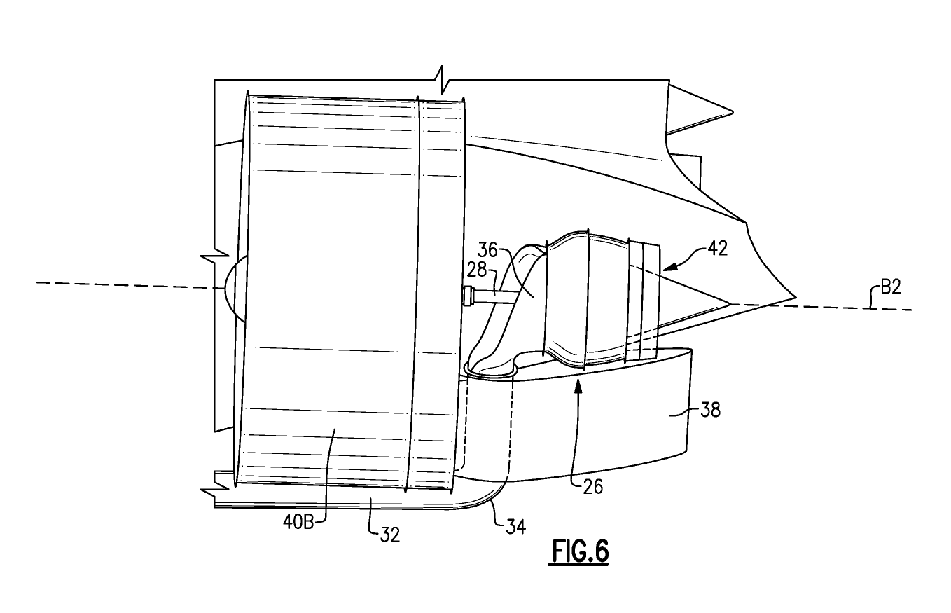

Referring to FIGS. 4 and 5 with continued reference to FIGS. 1, 2 and 3, the example propulsor 18 includes two fans 40A, 40B disposed at the aft portion 54 of the aircraft fuselage 52. The disclosed example includes two core engines 16A, 16B (FIG. 3) also referred to a gas generators that are embedded within the aircraft fuselage 52. The core engines 16A, 16B drive the two fans 40A, 40B disposed at the aft portion 54 of the aircraft fuselage 52. The core engines 16A, 16B are fed air through an air intake opening 12 and then through an internal inlet 14. The inlet 14 communicates the required air through the fuselage 52 to the core engines 16A, 16B.

Each of the example core engines 16A, 16B include at least one compressor section 20 that compresses incoming air and supplies that air to a combustor 22. In the combustor 22, gas is mixed with the air and ignited to generate a high energy exhaust flow that is expanded through at the turbine section 24.

In one disclosed example embodiment schematically shown in FIG. 4, the core engines 16A, 16B comprise a two-spool engine where a first spool includes a first compressor section 20a coupled to a first turbine section 24a and a second spool including a second compressor section 20b coupled to a second turbine section 24b. Each of the example core engines 16A, 16B drive a free turbine 26 that is driven by exhaust gases expelled from the turbine section 24. The free turbine 26 is not driven by a shaft from the corresponding core engine 16A and 16B. The free turbine 26 drives a gear system 35 through a shaft 28. The gear system 35 drives a corresponding fan 40A, 40B at a speed different than a speed of the free turbine 26. In one example embodiment, the gear system 35 provides a speed reduction that drives the corresponding fan 40A, 40B at a speed less than a speed of the corresponding free turbine 26.

The example core engines 16A and 16B are disposed at an angle 30A and 30B relative to a longitudinal axis C of the aircraft 10. The core engines 16A and 16B are also angled relative to axes B1 and B2 corresponding to the Fans 40A, 40B. The first fan 40A is disposed at an angle 35A relative to the core engine 16A. The second fan 40B is disposed at an angle 35B relative to the core engine 16B.

The core engines 16A and 16B are embedded within the aircraft fuselage 52 and are disposed substantially next to each other. The core engines 16A and 16B are angled outwardly relative to each other such that each engine is positioned outside of a burst zone of the other engine. The angled relative orientation of the core engines 16A and 16B ensure survivability of at least one engine in the event that one of the core engines 16A, 16B incurs a failure that renders it non-operational.

The fans 40A and 40B rotate about the separate axes B1, B2 that are spaced from the engine axes A1 and A2. Because the fans 40A, 40B are disposed aft of the core engines 16A, 16B, an additional drive shaft is not required to run along each engine axis. The shaft 28 through which the free turbine 26 drives the fan 40A, 40B does not need to pass through the center of the core engine 16A, 16B. Because an additional drive shaft is not needed, each of the core engines 16A, 16B may be of a reduced diameter as compared to traditional engines with a second shaft extending along the engine axis to drive a forward positioned fan. The reduced size enables improved engine operating efficiencies.

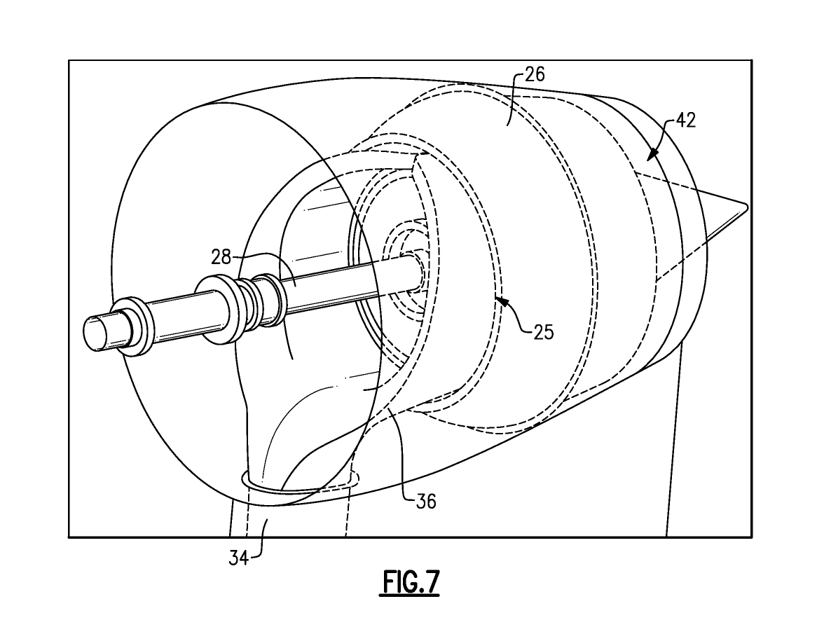

Referring to FIG. 6 with continued reference to FIGS. 3 and 5, the example fans 40A, 40B are each driven by the separate free turbine 26. FIG. 6 illustrates one free turbine 26 driving the fan 40B. Another free turbine 26 is provided to drive the other fan 40A. Each of the free turbines 26 are disposed aft of the core engine 16A, 16B and aft of the corresponding fans 40A, 40B. Each free turbine 26 drives a drive shaft 28 that in turn drives a corresponding one of the fans 40A, 40B. The drive shaft 28 is disposed along the fan axis B2. It should be understood that although the disclosed example aircraft 10 includes two core engines 16 and two fans 40, that any number of core engines may be utilized to drive one or more fans mounted within the aircraft.

The free turbine 26 is disposed aft of the fan 40B and receives gas flow through an exhaust duct 32. Gas flow provided by the core engine 16B expands through the free turbine 26 to drive the shaft 28. The exhaust duct 32 includes a turning portion 34 that is routed through a bifurcation 38. The bifurcation 38 is disposed within the propulsive flow from the fan 40B. A substantially identical configuration is provided between the core engine 16A and the free turbine 26 driving the other fan 40A.

The disclosed free turbine 26 receives exhaust gas flow about the axis B2. The turning duct 34 routes gasses through the bifurcation 38 and into an annular section 36. In the annular section 36, gas flow is turned in an axial direction along the axis B2 and wraps around the drive shaft 28. The free turbine 26 is not mechanically coupled to the corresponding core engine and is configured to rotate at speeds providing the most efficient propulsive operation of the fan 40A. Shaft speed may be modified by using a fan drive gear system 35. Exhaust gasses enter the free turbine 26 axially and exit out the free turbine exhaust 42 in an axial direction common with the axis B2.

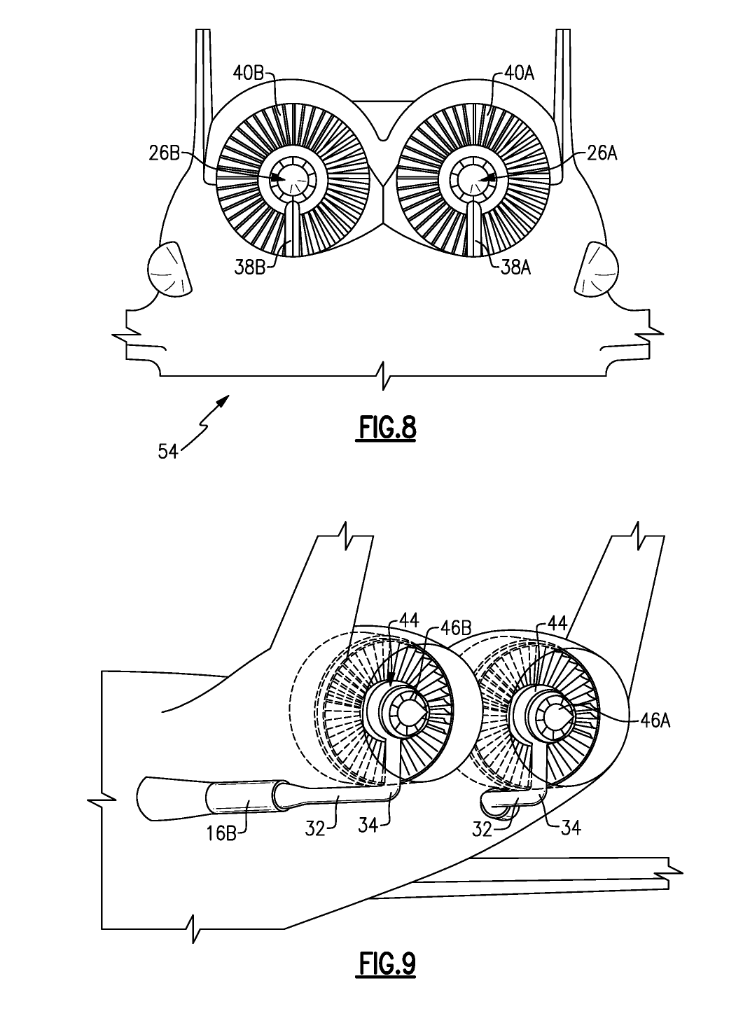

Referring to FIG. 7 with continued reference to FIG. 6, the example free turbine 26 receives gas flow through the annular section 36 that is communicated through the turning section 34. The annular section 36 originates at the radial inlet from the turning section 34 and wraps around the shaft 28 to form an annular outlet 25 into the free turbine 26. High energy exhaust gases from the core engine are of an elevated temperature and are therefore contained within the exhaust duct 32 and communicated through the free turbine 26. The annular section 36 isolates the shaft 28 from the high temperatures and pressures of the exhaust gas flow. Moreover, because the free turbine 26 is aft of the fan 40B, exhaust gases expelled from the free turbine 26 are advantageously not communicated through the fan 40B.

Referring to FIG. 8, each of the example turning sections 34 extend through a corresponding bifurcation 38A, 38B that extend through a flow path of air driven through the corresponding fan sections 40a, 40b. The example bifurcations 38A, 38B include features that minimize disruption of air flow through each of the fan sections 40a and 40b.

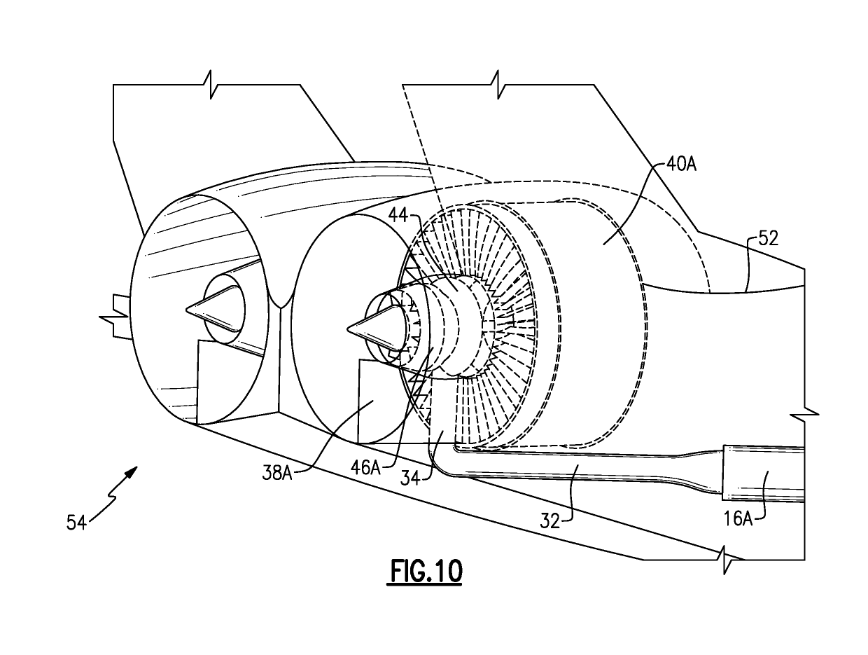

Referring to FIGS. 9 and 10, another example free turbine 46a and 46b is disclosed and is positioned aft of the corresponding fan 40A, 40B. The example free turbines 46A, 46B are radial turbines that receive exhaust gas flow radially through radial exhaust section 44. In this example, the exhaust duct 32 includes the turning section 34 that communicates air to the radial turbine 46a. Exhaust gas flow is not needed to be turned again axially but instead enters the free turbine 46a in a radial direction and powers the turbine section by rotating in a radial direction until it is exhausted through the aft portion of the free turbine 46a. Orientation of the radial free turbine instead of an axial free turbine enables exhaust gasses input into the radial turbine in a radial direction rather than requiring a second turning in an axial direction.

The example propulsor sections are driven by a free turbine disposed aft of each of the fan sections. Because the free turbine is provided separate from the core engine sections, the core engine sections may be smaller and more efficient. Moreover, by positioning the free turbines aft of fan sections, exhaust gasses from the free turbine do not interfere with operation of the fan section.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A gas turbine engine for an aircraft comprising:
a core engine assembly including a compressor section communicating air to a combustor section where the air is mixed with fuel and ignited to generate a high-energy gas flow that is expanded through a turbine section, wherein the turbine section is coupled to drive the compressor section;
a free turbine configured to be driven by gas flow from the core engine;
a propulsor section aft of the core engine and driven by the free turbine; and
an exhaust duct routing exhaust gases from the core engine to the free turbine, wherein the free turbine is disposed aft of the propulsor section and the exhaust duct includes an outlet aft of the propulsor section communicating gas flow to drive the free turbine.

2. The gas turbine engine as recited in claim 1, wherein the free turbine drives a shaft coupled to the propulsor section.

3. The gas turbine engine as recited in claim 2, including a gear system driven by the free turbine for driving the propulsor section at a speed different than a speed of the free turbine.

4. The gas turbine engine as recited in claim 2, wherein the free turbine comprises a radial inflow turbine and the outlet of the exhaust duct is disposed transverse to the radial inflow turbine to direct exhaust gas flow radially into the radial inflow turbine.

5. The gas turbine engine as recited in claim 2, wherein the free turbine comprises an axial inflow turbine and the outlet is disposed aft of the propulsor and forward of the axial inflow turbine.

6. The gas turbine engine as recited in claim 5, wherein exhaust duct includes an inflow section that communicates exhaust gases to the outlet, and the outlet is annular and surrounds the shaft.

7. The gas turbine engine as recited in claim 1, wherein the exhaust duct includes a turning portion that turns exhaust gas flow radially inward to the free turbine.

8. The gas turbine engine as recited in claim 7, including a bifurcation that extends through a flow path of the propulsor and the turning portion is disposed within the bifurcation.

9. The gas turbine engine as recited in claim 1, wherein the core engine is angled outward relative to a longitudinal axis of the aircraft.

10. The gas turbine engine as recited in claim 1, wherein the core engine comprises first and second core engines disposed within the aircraft and first and second propulsors driven by a corresponding first and second core engine.

11. An aircraft comprising:
a core engine assembly supported within an aircraft fuselage, the core engine assembly including a compressor section communicating air to a combustor section where the air is mixed with fuel and ignited to generate a high-energy gas flow that is expanded through a turbine section;
an air intake within the aircraft fuselage communicating air to the core engine assembly;
a propulsor section aft of the core engine; and
a free turbine configured to be driven by gas flow from the core engine, wherein the free turbine is aft of the propulsor section and drives a shaft coupled to the propulsor section; and
an exhaust duct routing exhaust gases from the core engine to the free turbine and the exhaust duct includes an outlet aft of the propulsor section communicating gas flow to drive the free turbine.

12. The aircraft as recited in claim 11, wherein the free turbine comprises a radial inflow turbine and the outlet of the exhaust duct is disposed transverse to the radial inflow turbine to direct exhaust gas flow radially into the radial inflow turbine.

13. The aircraft as recited in claim 11, including a gear system configured to drive the propulsor section at a speed different than that of the free turbine.

14. The aircraft as recited in claim 11, wherein the free turbine comprises an axial inflow turbine and the outlet is disposed aft of the propulsor and forward of the axial inflow turbine.

15. The aircraft as recited in claim 14, wherein exhaust duct includes an inflow section that communicates exhaust gases to the outlet, and the outlet is annular and surrounds the shaft.

16. The aircraft as recited in claim 11, wherein the exhaust duct includes a turning portion that turns exhaust gas flow radially inward to the free turbine.

17. The aircraft as recited in claim 16, including a bifurcation that extends through a flow path of the propulsor and the turning portion is disposed within the bifurcation.

18. The aircraft as recited in claim 11, wherein the core engine is angled outward relative to a longitudinal axis of the aircraft.

19. The aircraft as recited in claim 11, wherein the core engine comprises a first core engine and a second core engine disposed within the aircraft and the propulsor section comprises a first propulsor driven by the first core engine and a second propulsor driven by the second core engine.

20. The aircraft as recited in claim 19, wherein the first core engine and the second core engine are each angled outward relative to a longitudinal axis of the aircraft.
